(19) United States
(12) Patent Application Publication
(10) Pub. No.: US 2019/0086961 A1
(43) Pub. Date: Mar. 21, 2019

(54) FOLDABLE TOUCH DEVICE AND CONTROL METHOD THEREOF

(71) Applicant: INT TECH CO., LTD., HSINCHU COUNTY (TW)

(72) Inventor: KUO-CHENG HSU, TAICHUNG CITY (TW)

(21) Appl. No.: 15/710,564

(22) Filed: Sep. 20, 2017

(51) Int. Cl. G06F 1/16; G06F 3/044; G06F 3/041

(52) U.S. Cl. CPC G06F 1/1643; G06F 3/044; G06F 2203/04102; G06F 1/1652; G06F 3/0412; G06F 1/1641

(57) ABSTRACT

A foldable touch device includes several sections and at least one foldable section between and connected to two sections. Each of the sections and the at least one foldable section includes a touch component for implementing touch input from a respective surface. The at least one foldable section allows one or the sections to rotate with respect to another section along an axis to switching among different folded states.

### BACKGROUND

A touch device has been developed due to its slim size and intuitive interaction between the user and the device. The touch device may be applied to various kinds of electronic apparatus such as smart phone, notebook computer or the like. The applicability of conventional touch device, however, needs to be improved.

### SUMMARY

Embodiments of the present invention provide a foldable touch device. The foldable touch device includes a first section, a second section, a third section, a fourth section and a first foldable section. The first section includes a first touch component configured to touch input from a first surface. The second section is connected to the first section, and the second section includes a second touch component configured to touch input from a second surface. The third section includes a third touch component configured to touch input from a third surface. The fourth section is connected to the third section, and the fourth section includes a fourth touch component configured to touch input from a fourth surface. The first foldable section is between and connected to the second section and the fourth section, and configured for folding the section section with respect to the fourth section about an axis.

In an embodiment, the first surface, the second surface, the third surface and the fourth surface are flat surfaces.

In another embodiment, the first foldable section further includes a fifth touch component configured to touch input from a first foldable surface between and connected to the second surface and the fourth surface.

In yet another embodiment, the first foldable surface is a flat surface when the first foldable section is unfolded.

In still another embodiment, the first foldable surface is a curve surface when the first foldable section is folded.

In yet still another embodiment, the foldable touch device further includes a second foldable section and a third foldable section, wherein the first section and the second section are connected through the second foldable section, the second foldable section further includes a sixth touch component configured to touch input from a second foldable surface between and connected to the first surface and the second surface, the third section and the fourth section are connected through the third foldable section, and the third foldable section further includes a seventh touch component configured to touch input from a third foldable surface between and connected to the third surface and the fourth surface.

In an embodiment, the foldable touch device further includes at least one display panel disposed in the first section, the second section, the third section and the fourth section, and configured to display images from the first surface, the second surface, the third surface and the third surface.

In another embodiment, the foldable touch device includes a capacitive touch device.

In yet another embodiment, the foldable touch device further includes a sensor component configured to detect an orientation of the foldable touch device.

Some embodiments of the present invention provide a method for controlling the above foldable touch device. The method includes determining whether the first foldable section is folded or unfolded; and selectively enabling or disabling touch input functions of the first touch component, the second touch component, the third touch component and the fourth touch component based on a result of the determining whether the first foldable section is folded or unfolded.

In an embodiment, the determining whether the first foldable section is folded or unfolded is implemented by detecting an orientation of the foldable touch device.

In another embodiment, the determining whether the first foldable section is folded or unfolded by detecting a mutual capacitance between the first surface and the third surface.

In yet another embodiment, the selectively enabling or disabling touch input functions of the first touch component, the second touch component, the third touch component and the fourth touch component includes disabling touch input functions of one or more of the first touch component, the second touch component, the third touch component and the fourth touch component when sustained multi-point touch input is detected on the respective one or more of the first touch component, the second touch component, the third touch component and the fourth touch component.

In still another embodiment, the selectively enabling or disabling touch input functions of the first touch component, the second touch component, the third touch component and the fourth touch component includes enabling touch input functions of the first touch component, the second touch component, the third touch component and the fourth touch component.

In yet still another embodiment, the selectively enabling or disabling touch input functions of the first touch component, the second touch component, the third touch component and the fourth touch component includes enabling touch input functions of the first touch component and the third touch component and disabling touch input functions of the second touch component and the fourth touch component.

In another embodiment, the selectively enabling or disabling touch input functions of the first touch component, the second touch component, the third touch component and the fourth touch component includes enabling touch input functions of the second touch component and the fourth touch component and disabling touch input functions of the first touch component and the third touch component.

In yet another embodiment, the selectively enabling or disabling touch input functions of the first touch component, the second touch component, the third touch component and the fourth touch component includes enabling touch input function of the second touch component and disabling touch input functions of the first touch component, the third touch component and the fourth touch component.

In still another embodiment, the selectively enabling or disabling touch input functions of the first touch component, the second touch component, the third touch component and the fourth touch component includes enabling touch input function of the fourth touch component and disabling touch input functions of the first touch component, the second touch component and the third touch component.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic diagram of a foldable touch device in a first folded state in accordance with some embodiments of the present disclosure;

FIG. 1B is a schematic diagram of a foldable touch device in a second folded state in accordance with some embodiments of the present disclosure;

FIG. 2A is a schematic diagram of a foldable touch device in a front side touch input mode of the first folded state in accordance with some embodiments of the present disclosure;

FIG. 2B is a schematic diagram of a foldable touch device in a back side touch input mode of the first folded state in accordance with some embodiments of the present disclosure;

FIG. 3A is a schematic diagram of a foldable touch device in a front side touch input mode of the second folded state in accordance with some embodiments of the present disclosure;

FIG. 3B is a schematic diagram of a foldable touch device in a back side touch input mode of the second folded state in accordance with some embodiments of the present disclosure;

FIG. 4A is a schematic diagram of a foldable touch device in an unfolded state in accordance with some embodiments of the present disclosure;

FIG. 4B is a schematic diagram of a foldable touch device in a third folded state in accordance with some embodiments of the present disclosure;

FIG. 4C is a schematic diagram of a foldable touch device in a fourth folded state in accordance with some embodiments of the present disclosure;

FIG. 5 is a schematic diagram of a foldable touch device in accordance with some embodiments of the present disclosure;

FIG. 6 is a schematic diagram of a foldable touch device in accordance with some embodiments of the present disclosure;

FIG. 7 is a schematic diagram of a capacitive touch panel in accordance with some embodiments of the present disclosure;

FIG. 7A is a schematic diagram of the capacitive touch panel of FIG. 6 when a single-point touch input is implemented;

FIG. 7B is a schematic diagram of the capacitive touch panel of FIG. 6 when a sustained multi-point touch input is implemented; and

FIG. 8 is a flow chart illustrating a method for controlling a foldable touch device according to various aspects of one or more embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, it will be understood that when an element is referred to as being “connected to” or “coupled to” another element, it may be directly connected to or coupled to the other element, or intervening elements may be present.

Further, spatially relative terms, such as “beneath,” “below,” “lower,” “above,” “upper,” “on,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first”, “second” and “third” describe various elements, components, regions, layers and/or sections, these elements, components, regions, layers and/or sections should not be limited by these terms. These terms may be only used to distinguish one element, component, region, layer or section from another. The terms such as “first”, “second” and “third” when used herein do not imply a sequence or order unless clearly indicated by the context.

In some embodiments of the present disclosure, a foldable touch device including touch components for implementing touch input from different surfaces of the foldable touch device is provided. The foldable touch device may include several flat surfaces and curve surfaces to provide touch input functions there from. The foldable touch device is operable in different folded states and unfolded state. The foldable touch device is able to be switched among various touch input modes such as a double side touch input mode, a front side touch input mode and a back side touch input mode. In some embodiments of the present disclosure, a method for controlling the foldable touch device is further provided to selectively enable or disable touch input functions of some or all touch components to support various touch input modes of the foldable touch device in the folded state or the unfolded state. The foldable touch device may be integrated with at least one display panel to support various display modes such as a double side display mode, a front side display mode or a back side display mode in the folded state or in the unfolded state.

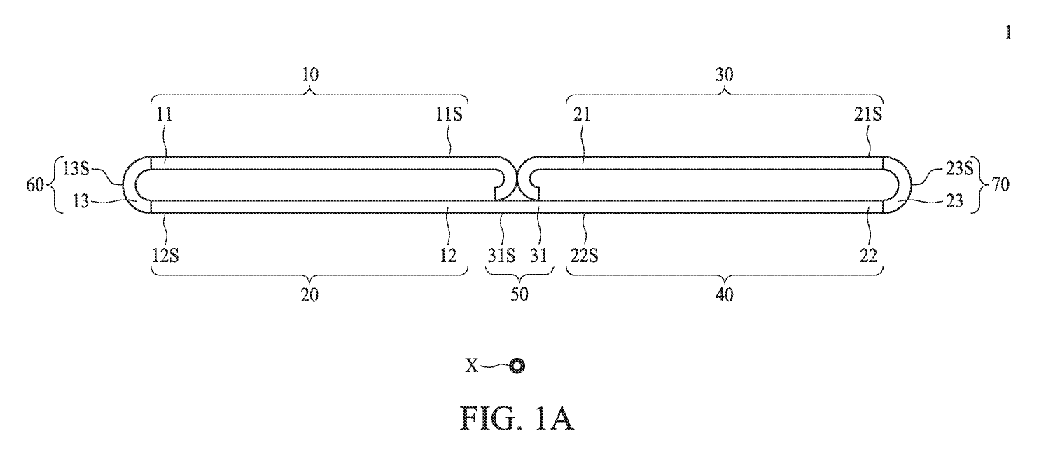

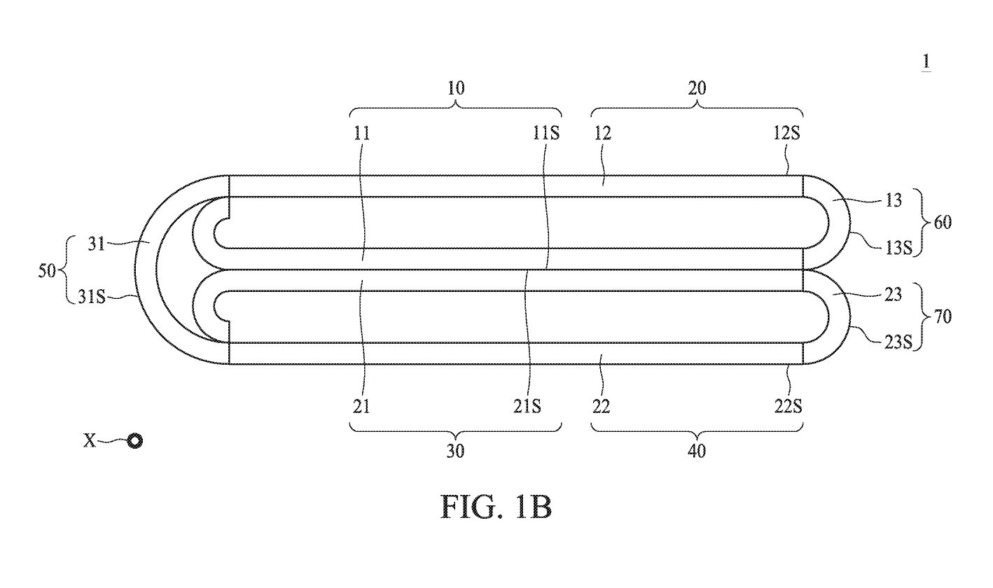

FIG. 1A is a schematic diagram of a foldable touch device in a first folded state in accordance with some embodiments of the present disclosure, and FIG. 1B is a schematic diagram of a foldable touch device in a second folded state in accordance with some embodiments of the present disclosure. As depicted in FIG. 1A and FIG. 1B, the foldable touch device 1 includes a first section 10, a second section 20, a third section 30, a fourth section 40 and a first foldable section 50 between and connected to the the second section 20 and the fourth section 40. In some embodiments, each of the first section 10, the second section 20, the third section 30 and the fourth section 40 may be rigid, flexible or bendable. The first section 10 includes a first touch component 11 configured to touch input from a first surface 11S. The second section 20 is connected to the first section 10, and the second section 20 includes a second touch component 12 configured to touch input from a second surface 12S. The third section 30 includes a third touch component 21 configured to touch input from a third surface 21S. The fourth section 40 is connected to the third section 30, and the fourth section 40 includes a fourth touch component 22 configured to touch input from a fourth surface 22S. In some embodiments, the first surface 11S, the second surface 12S, the third surface 21S and the fourth surface 22S may be flat surfaces, but are not limited thereto.

The first foldable section 50 is configured for folding the second section 20 with respect to the fourth section 40 about an axis X to switch among different folded or unfolded states. In some embodiments, the first foldable section 50 is pivotally mounted on the second section 20 with respect to the fourth section 40 such that the second section 20 and the fourth section 40 may be folded. In some alternative embodiments, the first foldable section 50 may be connected to the second section 20 and the fourth section 40 in other foldable or rotatable manners. In some embodiments, the first foldable section 50 may further includes a fifth touch component 31 configured to touch input from a first foldable surface 31S between and connected to the second surface 12S and the fourth surface 22S. In some embodiments, the first foldable surface 31S may be formed from an extendable material, which may be extended in the folded state. By way of examples, the first foldable surface 31S may be a flat surface when the first foldable section 50 is unfolded, and the first foldable surface 31S may be a curve surface when the first foldable section 50 is folded. In some embodiments, the second surface 12S, the first foldable surface 31S and the fourth surface 22S may be connected in a seamless manner such that the user may implement touch input throughout the second section 20, the first foldable section 50 and the fourth section 40.

In some embodiments, the foldable touch device 1 may further include a second foldable section 60 and a third foldable section 70. The first section 10 and the second section 20 may be connected through the second foldable section 60. In some embodiments, the second foldable section 60 may further include a sixth touch component 13 configured to touch input from a second foldable surface 13S between and connected to the first surface 11S and the second surface 12S. The third section 30 and the fourth section 40 may be connected through the third foldable section 70. In some embodiments, the third foldable section 70 may further include a seventh touch component 23 configured to touch input from a third foldable surface 23S between and connected to the third surface 21S and the fourth surface 22S. In some embodiments, the second foldable surface 13S and the third foldable surface 23S may be formed from an extendable material, which may be extended in the folded state. In some embodiments, the first surface 11S, the second foldable surface 13S and the second surface 12S may be connected in a seamless manner such that the user may implement touch input throughout the first section 10, the second foldable section 60 and the second section 20. Similarly, the third surface 21S, the third foldable surface 23S and the fourth surface 22S may be connected in a seamless manner such that the user may implement touch input throughout the third section 30, the third foldable section 70 and the fourth section 40.

In some embodiments, the foldable touch device 1 may be operated in different folding states and touch input modes. As shown in FIG. 1A, in the first folded state, the first foldable section 50 is unfolded while the second foldable section 60 and the third foldable section 70 are folded. In the first folded state, the first touch component 11, the second touch component 12, the third touch component 21 and the fourth touch component 22 may be all enabled to implement touch input function through the first surface 11S, the second surface 12S, the third surface 21S and the fourth surface 22S. In some embodiments, the fifth touch component 31, the sixth touch component 13 and the seventh touch component 23 may also be enabled to implement touch input function through the first foldable surface 31S, the second foldable surface 13S and the third foldable surface 23S.

As shown in FIG. 1B, in the second folded state, the first foldable section 50, the second foldable section 60 and the third foldable section 70 are all folded. In some embodiments, the foldable touch device 1 may include a double side touch input mode under the second folded state. In the double side touch input mode, the first touch component 11 and the third touch component 21 may be disabled while the second touch component 12 and the fourth touch component 22 may be enabled to implement touch input functions through the second surface 12S and the fourth surface 22S. In some embodiments, the fifth touch component 31, the sixth touch component 13 and the seventh touch component 23 may also be enabled to implement touch input function through the first foldable surface 31S, the second foldable surface 13S and the third foldable surface 23S.

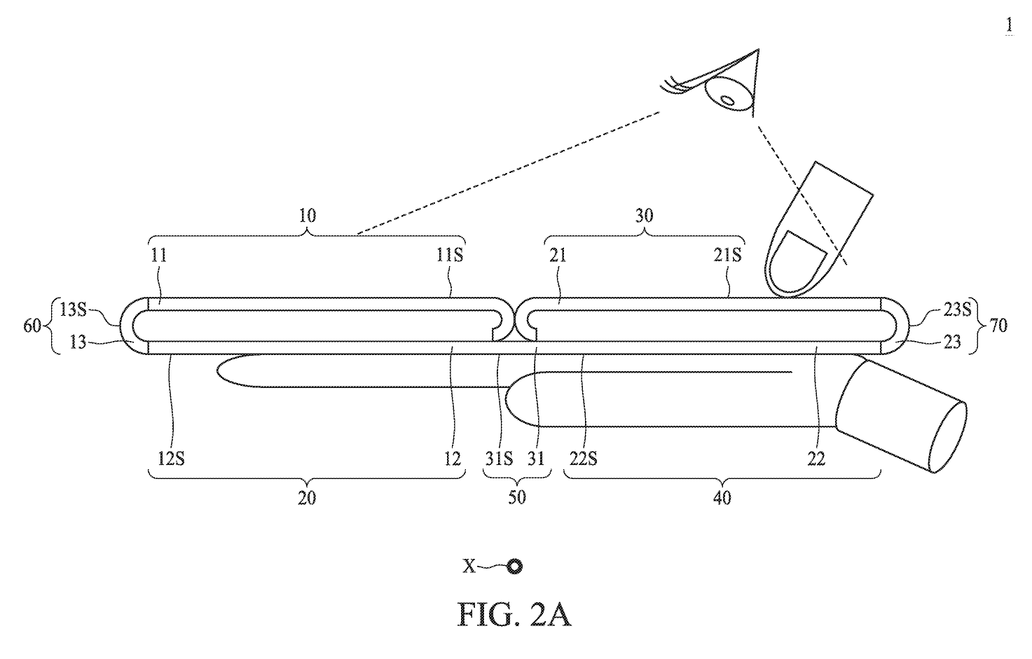

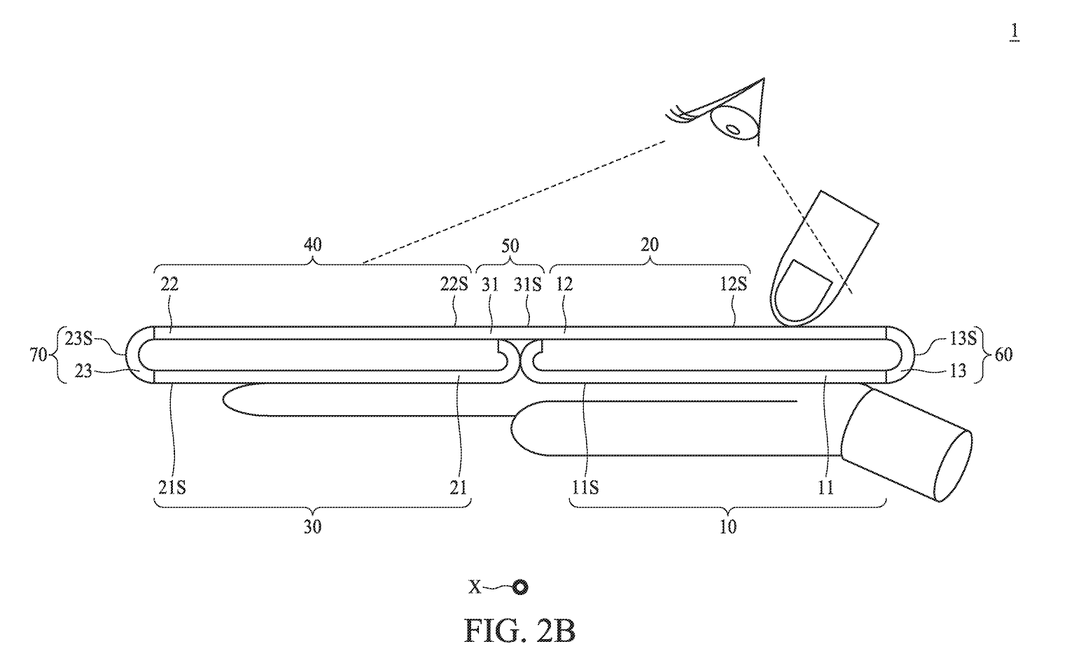

In some alternative embodiments, the first folded state may further include several touch input modes such as a front side touch input mode and a back side touch input mode. FIG. 2A is a schematic diagram of a foldable touch device in a front side touch input mode of the first folded state in accordance with some embodiments of the present disclosure, and FIG. 2B is a schematic diagram of a foldable touch device in a back side touch input mode of the first folded state in accordance with some embodiments of the present disclosure. As depicted in FIG. 2A, in the front side touch input mode of the first folded state, the second surface 12S and the fourth surface 22S may be held, by e.g. the user's hand, and touch input functions of the second touch component 12 and the fourth touch component 22 may be disabled to save power and to avoid accidental operation. Meanwhile, the first touch component 11 and the third touch component 21 may be enabled to implement touch input functions through the first surface 11S and the third surface 21S. As depicted in FIG. 2B, in the back side touch input mode of the first folded state, the first surface 11S and the third surface 21S may be held, by e.g. the user's hand, and touch input functions of the first touch component 11 and the third touch component 21 may be disabled to save power and to avoid accidental operation. Meanwhile, the second touch component 12 and the fourth touch component 22 may be enabled to implement touch input functions through the second surface 12S and the fourth surface 22S.

In some embodiments, the second folded state may further include several touch input modes such as a front side touch input mode and a back side touch input mode as illustrated in the following description.

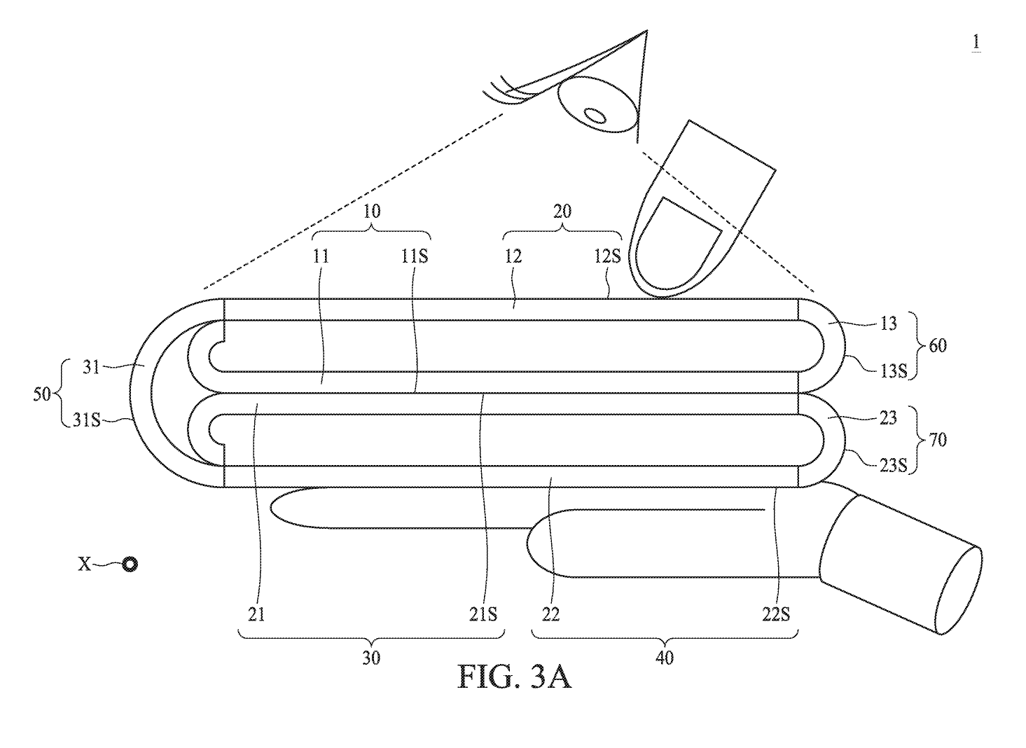

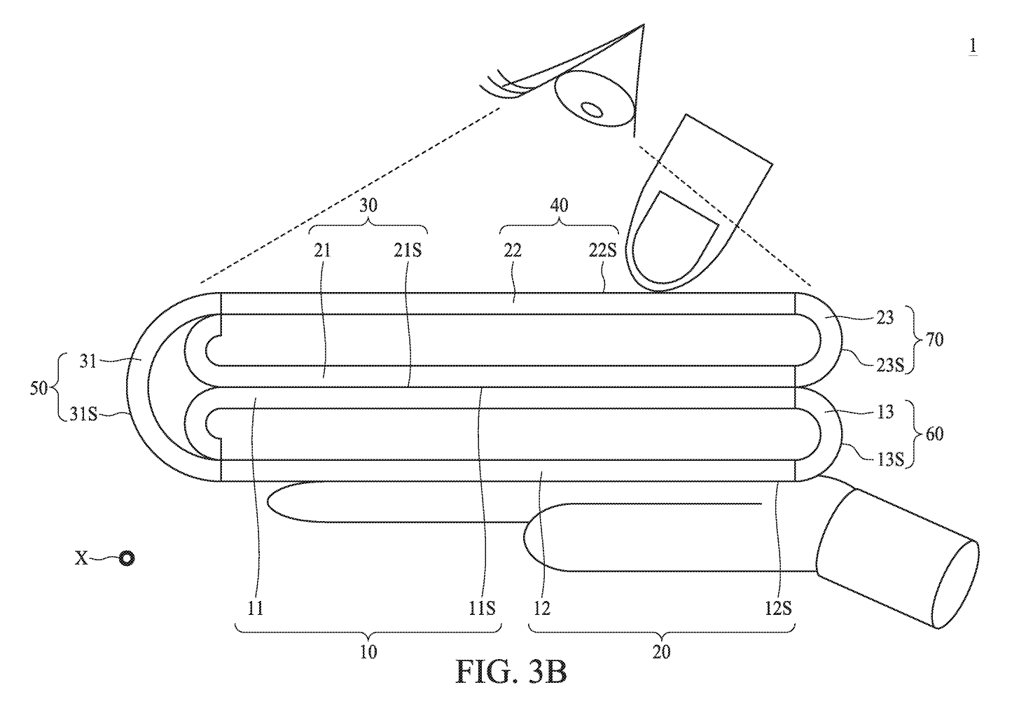

FIG. 3A is a schematic diagram of a foldable touch device in a front side touch input mode of the second folded state in accordance with some embodiments of the present disclosure, and FIG. 3B is a schematic diagram of a foldable touch device in a back side touch input mode of the second folded state in accordance with some embodiments of the present disclosure. As depicted in FIG. 3A, in the front side touch input mode of the second folded state, the fourth surface 22S may be held, by e.g. the user's hand, and the first surface 11S and the third surface 21S are folded. Thus, touch input functions of the first touch component 11, the third touch component 21 and the fourth touch component 22 may be disabled to save power and to avoid accidental operation. Meanwhile, the second touch component 12 may be enabled to implement touch input function through the second surface 12S. As depicted in FIG. 3B, in the back side touch input mode of the second folded state, the second surface 12S may be held, by e.g. the user's hand, and the first surface 11S and the third surface 21S are folded. Thus, touch input functions of the first touch component 11, the second touch component 12 and the third touch component 21 may be disabled to save power and to avoid accidental operation. Meanwhile, the fourth touch component 22 may be enabled to implement touch input function through the fourth surface 22S.

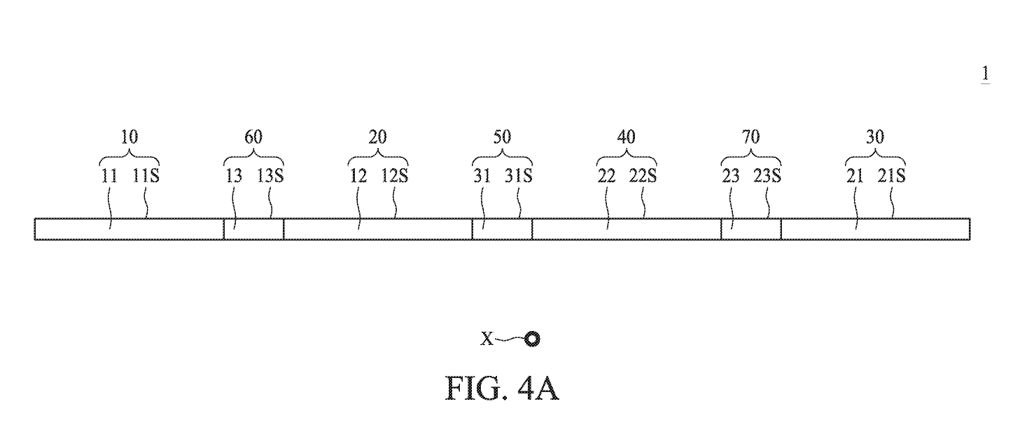

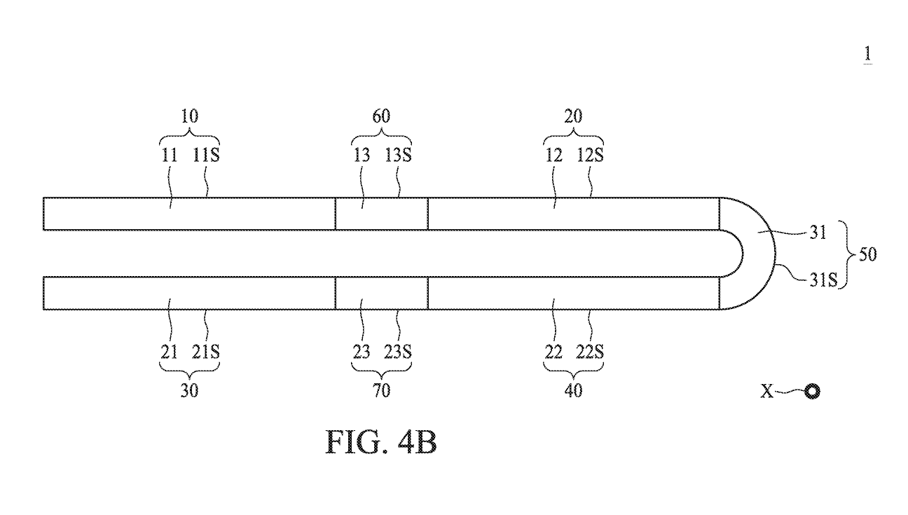

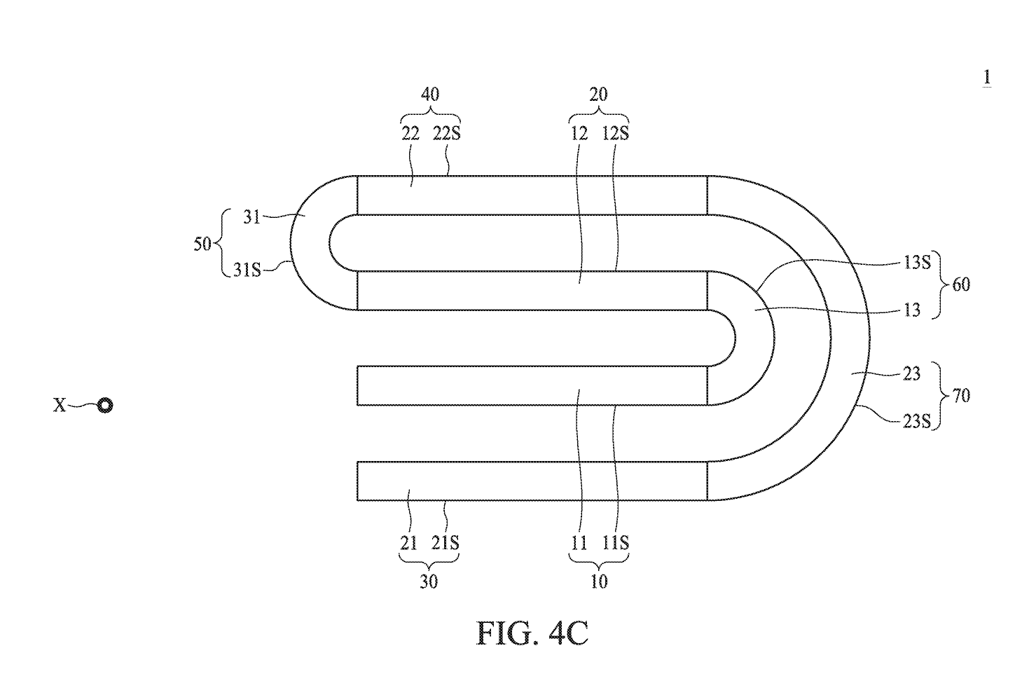

FIG. 4A is a schematic diagram of a foldable touch device in an unfolded state in accordance with some embodiments of the present disclosure. As depicted in FIG. 4A, in the unfolded state, the first foldable section 50, the second foldable section 60 and the third foldable section 70 are all unfolded. In some embodiments, the first touch component 11, the second touch component 12, the third touch component 21 and the fourth touch component 22 may be all enabled to implement touch input function through the first surface 11S, the second surface 12S, the third surface 21S and the fourth surface 22S. In some embodiments, the fifth touch component 31, the sixth touch component 13 and the seventh touch component 23 may also be enabled to implement touch input function through the first foldable surface 31S, the second foldable surface 13S and the third foldable surface 23S.

FIG. 4B is a schematic diagram of a foldable touch device in a third folded state in accordance with some embodiments of the present disclosure. As shown in FIG. 4B, in the third folded state, the first foldable section 50 is folded, while the second foldable section 60 and the third foldable section 70 are unfolded. In some embodiments, the foldable touch device 1 may include a double side touch input mode under the third folded state. In the double side touch input mode of the third folded mode, the first touch component 11, the second touch component 12, the third touch component 21 and the fourth touch component 22 may be all enabled to implement touch input function through the first surface 11S, the second surface 12S, the third surface 21S and the fourth surface 22S. In some embodiments, the fifth touch component 31, the sixth touch component 13 and the seventh touch component 23 may also be enabled to implement touch input function through the first foldable surface 31S, the second foldable surface 13S and the third foldable surface 23S. In some embodiments, the foldable touch device 1 may include a front side touch input mode or a back side touch input mode under the third folded state, and respective touch components may be enabled accordingly.

FIG. 4C is a schematic diagram of a foldable touch device in a fourth folded state in accordance with some embodiments of the present disclosure. As shown in FIG. 4C, in the fourth folded state, the first foldable section 50, the second foldable section 60 and the third foldable section 70 are folded in a different manner than the second folded state. In some embodiments, the foldable touch device 1 may include a double side touch input mode under the fourth folded state. In the double side touch input mode of the fourth folded state, the third touch component 21 and the fourth touch component 22 may be enabled to implement touch input function through the third surface 21S and the fourth surface 22S, while the first touch component 11 and the second touch component 12 may be disabled, In some embodiments, the fifth touch component 31 and the seventh touch component 23 may also be enabled to implement touch input function through the first foldable surface 31S and the third foldable surface 23S, while the sixth touch component 13 may be disabled.

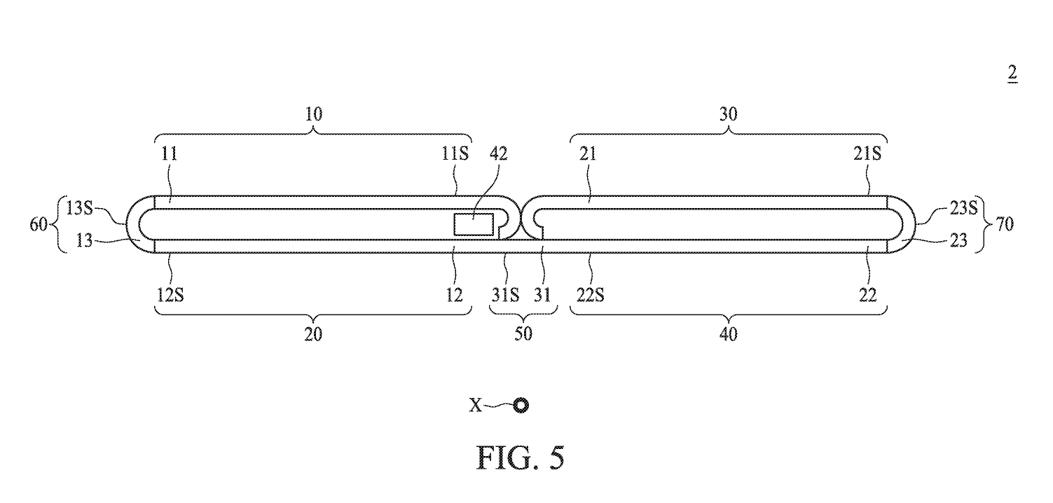

FIG. 5 is a schematic diagram of a foldable touch device in accordance with some embodiments of the present disclosure. As depicted in FIG. 5, the foldable touch device 2 may further include one or more sensor component 42 configured to detect an orientation of the foldable touch device 2. The sensor component 42 may be disposed in or on any locations of the foldable touch device 2. By way of example, the sensor component 42 may be disposed in the first section 10, the second section 20, the third second 30, the fourth section 40, the first foldable section 50, the second foldable section 60 and the third foldable section 70. In some embodiments, the sensor component 42 may include a motion sensor component such as a gyroscope component, an inertial sensor component or the like. The sensor component 42 is configured to detect whether the foldable touch device 2 is in the folded state or the unfolded state.

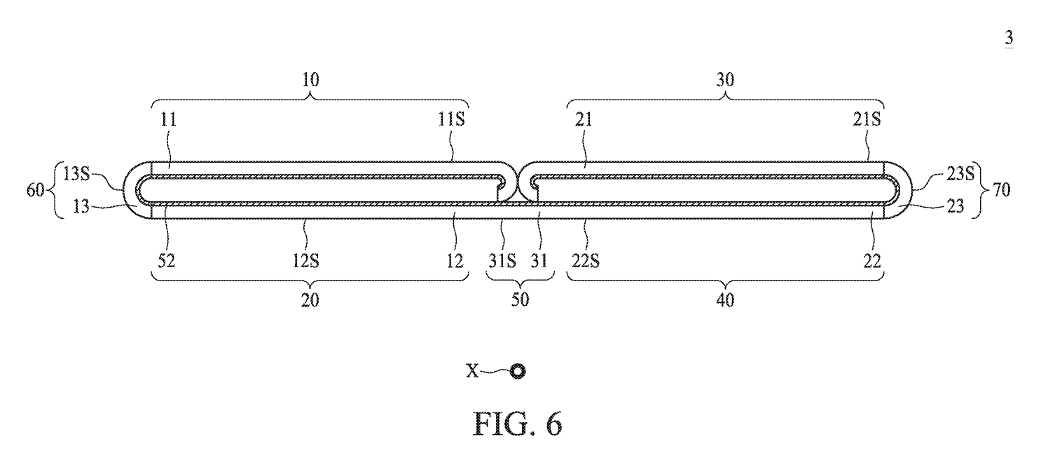

FIG. 6 is a schematic diagram of a foldable touch device in accordance with some embodiments of the present disclosure. As depicted in FIG. 6, the foldable touch device 3 may further include at least one display panel 52 disposed in the first section 10 and the second section 20. The display panel 52 is configured to display images from the first surface 11S, the second surface 12S, the third surface 21S and the third surface 22S. In some embodiments, the display panel 52 may further be configured to display images from the first foldable surface 31S, the second foldable surface 13S and the third foldable surface 23S. In some embodiments, the display panel 52 may include a rigid display panel, a flexible display panel or a bendable display panel such as a liquid crystal display (LCD) panel, an organic light-emitting diode (OLED) display panel, an electrophoretic display (EPD) panel or the like. In some embodiments, the display panel 52 may be selectively enabled or disabled along with the respective touch components to support various display modes such as a double side display mode, a front side display mode or a back side display mode in the folded state or in the unfolded state. The foldable touch device 3 is advantageous due to it high screen ratio.

In some embodiments, the foldable touch device of the present disclosure may include a capacitive touch device. For example, each of the first touch component 11, the second touch component 12, the third touch component 21, the fourth touch component 22, the fifth touch component 31, the sixth touch component 13 and the seventh touch component 23 may be a capacitive touch panel. In some embodiments, some or all of the capacitive touch panels may be formed integrally. In some embodiments, the capacitive touch panel can be driven in a self-capacitive manner, a mutual-capacitive manner or a combination thereof.

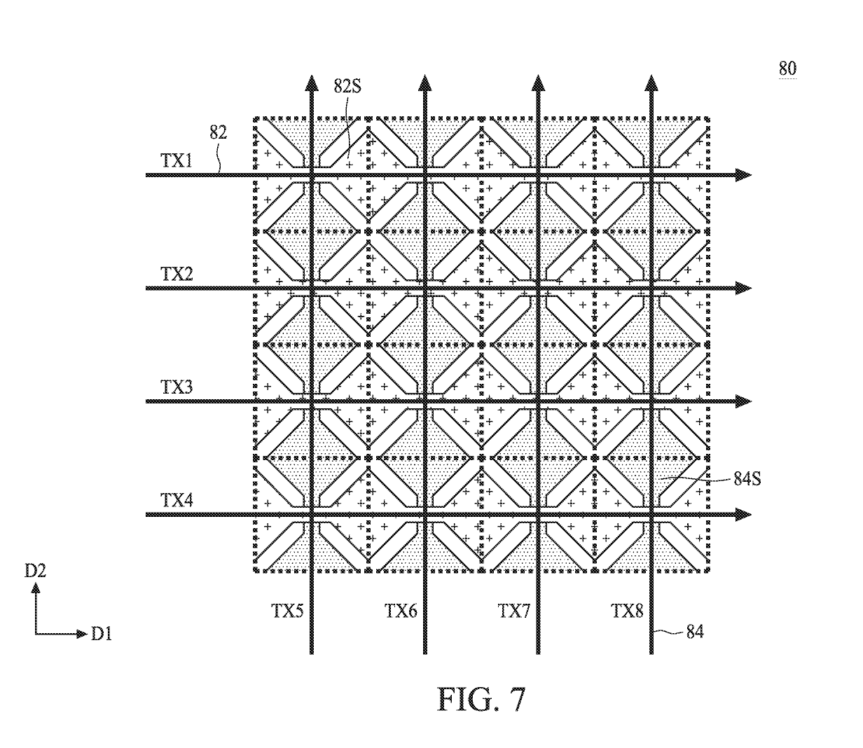

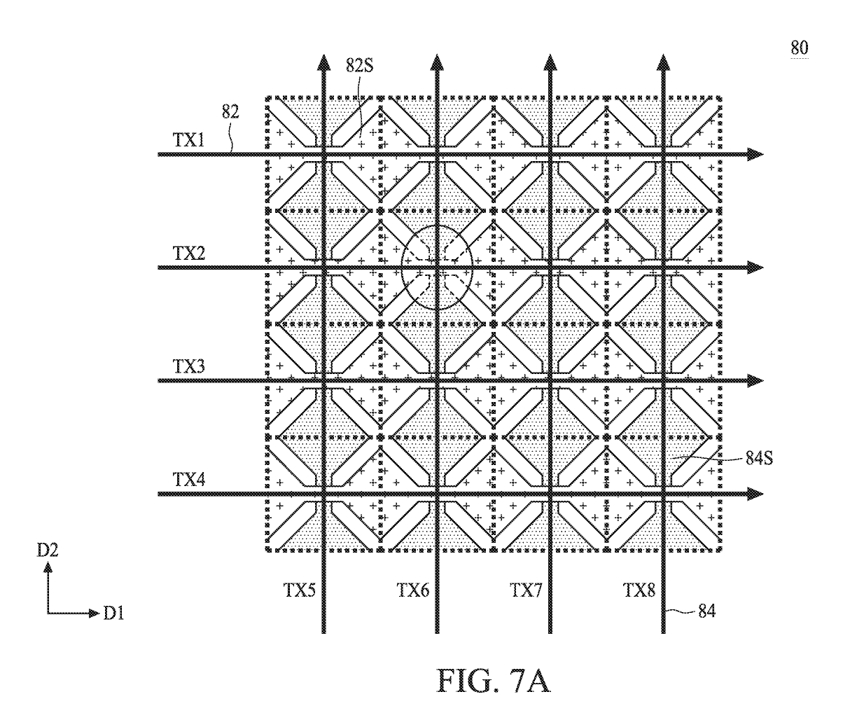

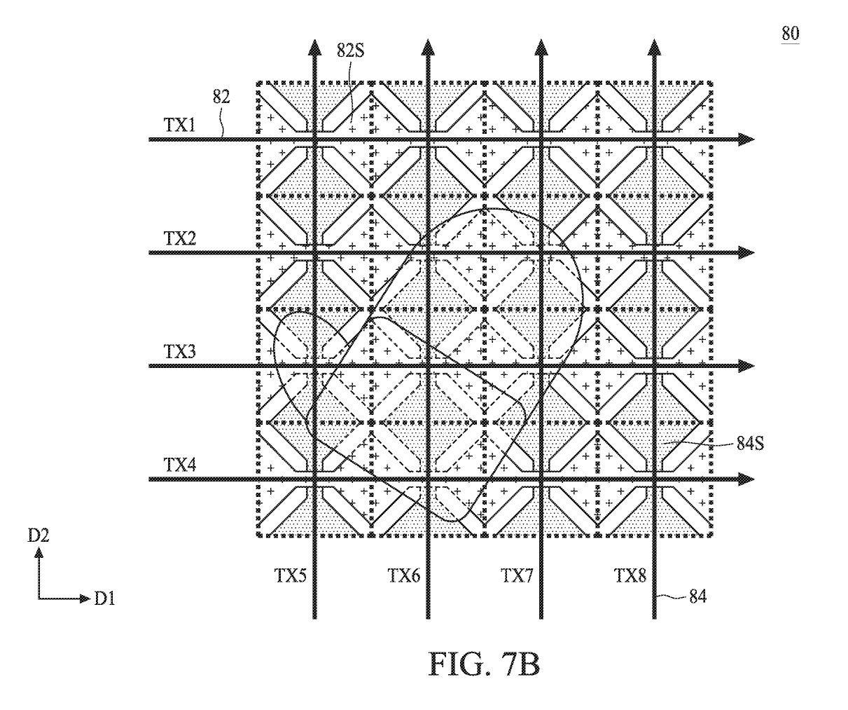

Refer to FIG. 7, FIG. 7A and FIG. 7B. FIG. 7 is a schematic diagram of a capacitive touch panel in accordance with some embodiments of the present disclosure, FIG. 7A is a schematic diagram of the capacitive touch panel of FIG. 7 when a single-point touch input is implemented, and FIG. 7B is a schematic diagram of the capacitive touch panel of FIG. 7 when a sustained multi-point touch input is implemented. As depicted in FIG. 7, the capacitive touch panel 80 may include first sensing lines 82 arranged in a first direction D1 such as the horizontal direction, and second sensing lines 84 arranged in a second direction D2 such as the vertical direction. The first sensing lines 82 and the second sensing lines 84 are electrically disconnected from one another. In some embodiments, each of the first sensing lines 82 may include first sensing electrodes 82S electrically connected to each other, and each of the second sensing lines 84 may include second sensing electrodes 84S. In some embodiments, the capacitive touch panel 80 may be driven in a self-capacitive manner by providing transmitting signals such as Tx1, Tx2, Tx3 and Tx4 through the first sensing lines 82 sequentially, and Tx5, Tx6, Tx7 and Tx8 through the second sensing lines 84 sequentially from a driver circuit (not shown). A touch input apparatus such as finger or hand of the user or a stylus pen can cause capacitance variations to the respective sensing lines, and thus touch input may be detected. In some embodiments, the capacitive touch panel 80 may also be driven in a mutual-capacitive manner, by providing transmitting signals such as Tx1, Tx2, Tx3 and Tx4 through the first sensing lines 82, and obtaining receiving signals. In some embodiments, the self-capacitive driving method and the mutual-capacitive driving method may be alternately used. For example, the self-capacitive driving method may be used to determine whether or not to disable one or more respective touch components, and the mutual-capacitive driving method may be used to implement normal touch input function.

As depicted in FIG. 7A, a single-point touch input is implemented on a point adjacent to the intersection of the 2nd first sensing line 82 and the 2nd second sensing line 84. For example, the transmitting signals Tx2 and Tx6 may be capacitively coupled and monitored by the driver circuit, and thus the coordinates of the touch input point can be detected. When a multi-point touch is implemented on several points, the coordinates of the touch input points can also be detected.

As depicted in FIG. 7B, when a sustained multi-point touch input that lasts on the capacitive touch panel 80 for a longer period is detected, the sustained multi-point touch input may be determined as the user is holding the capacitive touch panel 80.

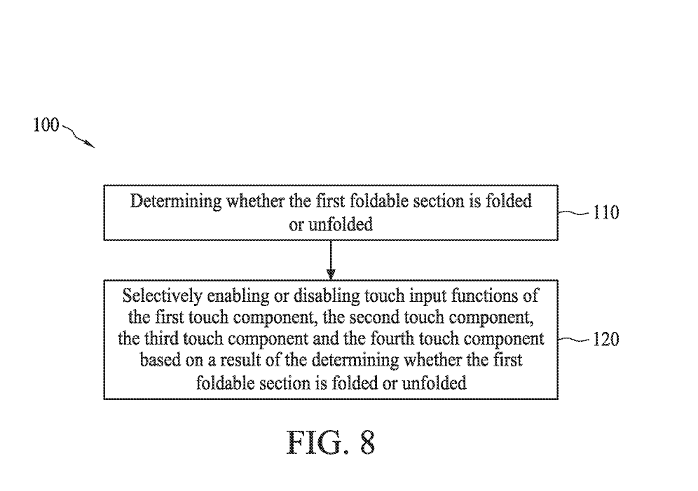

In some embodiments of the present disclosure, the foldable touch device may be operated by different controlling methods in different touch input modes. Referring to FIG. 8, FIG. 8 is a flow chart illustrating a method for controlling a foldable touch device according to various aspects of one or more embodiments of the present disclosure. The method 100 begins with operation 110 in which whether the first foldable section is folded or unfolded is determined. The method proceeds with operation 120 in which touch input functions of the first touch component, the second touch component, the third touch component and the fourth touch component are selectively enabled or disabled based on a result of the determining whether the first foldable section is folded or unfolded.

In some embodiments, the first foldable section is determined to be folded or unfolded by detecting an orientation of the foldable touch device. By way of example, the orientation of the foldable touch device may be detected by the sensor component 42 as shown in FIG. 5.

In some embodiments, the first foldable section is determined to be folded or unfolded when a mutual capacitance is detected between the first surface 11S and the third surface 21S as shown in FIG. 1B.

In some embodiments, touch input functions of one or more of the first touch component 11, the second touch component 12, the third touch component 21 and the fourth touch component 22 are disabled when sustained multi-point touch input is detected on the respective one or more of the first touch component 11, the second touch component 12, the third touch component 21 and the fourth touch component 22.

In some embodiments, touch input functions of the first touch component 11, the second touch component 12, the third touch component 21 and the fourth touch component 22 are enabled by e.g., a processor (not shown) when the first foldable section is in the first folded state as shown in FIG. 1A.

In some embodiments, touch functions of the first touch component 11 and the third touch component 21 are enabled, and touch functions of the second touch component 12 and the fourth touch component 22 are disabled by e.g., a processor (not shown). In such a case, the foldable touch device is in a front side touch input mode of the first folded state as shown in FIG. 2A.

In some embodiments, touch input functions of the second touch component 12 and the fourth touch component 22 are enabled, and touch input functions of the first touch component 11 and the third touch component 21 are disabled by e.g., a processor (not shown). In such a case, the foldable touch device is in a back side touch input mode of the first folded state as shown in FIG. 2B.

In some embodiments, touch input functions of the second touch component 12 is enabled, and touch input functions of the first touch component 11, the third touch component 21 and the fourth touch component 22 are disabled by e.g., a processor (not shown). In such a case, the foldable touch device is in a front side touch input mode of the second folded state as shown in FIG. 3A.

In some embodiments, touch input functions of the fourth touch component 22 is enabled, and touch input functions of the first touch component 11, the second touch component 12 and the third touch component 21 are disabled by e.g., a processor (not shown). In such a case, the foldable touch device is in a back side touch input mode of the second folded state as shown in FIG. 3B.

In some embodiments of the present disclosure, the foldable touch device includes several sections, and at least one foldable section between and connected to two sections. Each of the sections and the at least one foldable section includes a touch component for implementing touch input from a respective surface. The foldable touch device may be operable in different desired folded states and unfolded states. The foldable touch device is able to be switched among various touch input modes. The applicability of the foldable touch device is therefore improved. The foldable touch device may be integrated with at least one display panel to support various display modes in different folded states or unfolded states.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A foldable touch device, comprising:
a first section including a first touch component configured to touch input from a first surface;
a second section connected to the first section the second section including a second touch component configured to touch input from a second surface;
a third section including a third touch component configured to touch input from a third surface;
a fourth section connected to the third section, the fourth section including a fourth touch component configured to touch input from a fourth surface; and
a first foldable section between and connected to the second section and the fourth section, and configured for folding the second section with respect to the fourth section about an axis;
wherein the first foldable surface is a curve surface when the first foldable section is folded.

2. The foldable touch device of claim 1, wherein the first surface, the second surface, the third surface and the fourth surface are flat surfaces.

3. The foldable touch device of claim 1, wherein the first foldable section further comprises a fifth touch component configured to touch input from a first foldable surface between and connected to the second surface and the fourth surface.

4. The foldable touch device of claim 3, wherein the first foldable surface is a flat surface when the first foldable section is unfolded.

5. (canceled)

6. The foldable touch device of claim 1, further comprising:
a second foldable section, wherein the first section and the second section are connected through the second foldable section, and the second foldable section further comprises a sixth touch component configured to touch input from a second foldable surface between and connected to the first surface and the second surface; and
a third foldable section, wherein the third section and the fourth section are connected through the third foldable section, and the third foldable section further comprises a seventh touch component configured to touch input from a third foldable surface between and connected to the third surface and the fourth surface.

7. The foldable touch device of claim 1, further comprising at least one display panel disposed in the first section, the second section, the third section and the fourth section, and configured to display images from the first surface, the second surface, the third surface and the third surface.

8. The foldable touch device of claim 1, wherein the foldable touch device comprises a capacitive touch device.

9. The foldable touch device of claim 1, further comprising a sensor component configured to detect an orientation of the foldable touch device.

10. A method for controlling the foldable touch device of claim 1, comprising:
determining whether the first foldable section is folded or unfolded; and
selectively enabling or disabling touch input functions of the first touch component, the second touch component, the third touch component and the fourth touch component based on a result of the determining whether the first foldable section is folded or unfolded.

11. The method of claim 10, wherein the determining whether the first foldable section is folded or unfolded is implemented by detecting an orientation of the foldable touch device.

12. The method of claim 10, wherein the determining whether the first foldable section is folded or unfolded by detecting a mutual capacitance between the first surface and the third surface.

13. The method of claim 10, wherein the selectively enabling or disabling touch input functions of the first touch component, the second touch component, the third touch component and the fourth touch component comprises disabling touch input functions of one or more of the first touch component, the second touch component, the third touch component and the fourth touch component when sustained multi-point touch input is detected on the respective one or more of the first touch component, the second touch component, the third touch component and the fourth touch component.

14. The method of claim 10, wherein the selectively enabling or disabling touch input functions of the first touch component, the second touch component, the third touch component and the fourth touch component comprises enabling touch input functions of the first touch component, the second touch component, the third touch component and the fourth touch component.

15. The method of claim 10, wherein the selectively enabling or disabling touch input functions of the first touch component, the second touch component, the third touch component and the fourth touch component comprises enabling touch input functions of the first touch component and the third touch component and disabling touch input functions of the second touch component and the fourth touch component.

16. The method of claim 10, wherein the selectively enabling or disabling touch input functions of the first touch component, the second touch component, the third touch component and the fourth touch component comprises enabling touch input functions of the second touch component and the fourth touch component and disabling touch input functions of the first touch component and the third touch component.

17. The method of claim 10, wherein the selectively enabling or disabling touch input functions of the first touch component, the second touch component, the third touch component and the fourth touch component comprises enabling touch input function of the second touch component and disabling touch input functions of the first touch component, the third touch component and the fourth touch component.

18. The method of claim 10, wherein the selectively enabling or disabling touch input functions of the first touch component, the second touch component, the third touch component and the fourth touch component comprises enabling touch input function of the fourth touch component and disabling touch input functions of the first touch component, the second touch component and the third touch component.
